(19) United States
(12) Patent Application Publication
(10) Pub. No.: US 2021/0121984 A1
(43) Pub. Date: Apr. 29, 2021

(54) METHOD OF PROCESSING FRP

(71) Applicant: PHOENIX ELECTRIC CO., LTD., Hyogo (JP)

(72) Inventors: Tetsuya GOUDA, Hyogo (JP); Takeshi MATSUDA, Hyogo (JP)

(21) Appl. No.: 17/076,351

(22) Filed: Oct. 21, 2020

(30) Foreign Application Priority Data
Oct. 25, 2019 (JP) 2019-194036

(51) Int. Cl. B23K 26/36

(52) U.S. Cl. CPC B23K 26/36

(57) ABSTRACT

A laser beam is irradiated onto a surface of FRP to remove thermosetting resin in an irradiated position of the laser beam such that fiber material contained in the FRP is exposed.

### CROSS REFERENCE OF RELATED APPLICATION

This application claims the priority of Japanese Patent Application No. 2019-194036 filed on Oct. 25, 2019, which are incorporated by reference herein.

### BACKGROUND OF THE INVENTION

### Field of the Invention

The present invention relates to a method of processing FRP (Fiber Reinforced Plastic).

### Background Art

FRP, especially, CFRP (Carbon Fiber Reinforced Plastic) is plastic material using carbon fiber as reinforcement material and has been widely used not only for airplanes and automobiles but also, in recent years, for buildings, bridges, and so forth.

CFRP thus widely used has degraded with time or the surface thereof has been damaged. Hence, demands have emerged for repairing CFRP.

For example, Japan Laid-open Patent Application Publication No. 2014-169409 discloses a device for repairing CFRP. The device repairs CFRP by injecting a repairing agent into a damaged part of the CFRP from outside.

However, the method of repairing CFRP disclosed in Japan Laid-open Patent Application Publication No. 2014-169409 had posed drawbacks of narrow versatility, high complexity, and high cost.

With widening of application of FRP, disposal of used FRP has been a social problem. Hence, establishing a method of recycling FRP has been demanded in addition to repairing FRP as described above.

Now, CFRP has been recycled, for instance, generally by heating CFRP in a large furnace to burn plastic (thermosetting resin) and then retrieving carbon fiber left unburnt.

This method is effective in that a large amount of waste CFRP is processable. However, this method has posed a drawback of necessity for extensive facility.

For the purpose of repairing or recycling FRP, it is generally important to remove plastic (thermosetting resin) by remaining only fiber material functioning as reinforcement material. When only thermosetting resin is removable, FRP is repairable by filling thermosetting resin again. Also, when only fiber material is extractable by removing all thermosetting resin, the fiber material left unremoved is recyclable.

The present invention has been produced in view of the drawbacks described above. It is an object of the present invention to provide a method of processing FRP whereby thermosetting resin is removable from FRP in an easy and convenient manner.

### SUMMARY OF THE INVENTION

According to an aspect of the present invention, a method of processing FRP is provided that includes the following step: irradiating a laser beam onto a surface of the FRP to remove thermosetting resin from the FRP in an irradiated position of the laser beam such that fiber material contained in the FRP is exposed.

Preferably, in the method, the fiber material is exposed by removing the thermosetting resin to a predetermined depth in a thickness direction of the FRP.

Preferably, the method further includes the following steps: irradiating a plurality of laser beams including the laser beam in irradiated positions at least aligned in a row away from each other at a predetermined interval; and moving the plurality of laser beams in a direction orthogonal to the row of the irradiated positions of the plurality of laser beams.

Preferably, in the method, a plurality of laser beams including the laser beam are irradiated onto the surface of the FRP in the irradiated position of the laser beam as a single irradiation position in a superimposed manner.

According to the present invention, by irradiating the laser beam on the surface of the FRP, the thermosetting resin is removed in the irradiated position, whereby the fiber material contained in the FRP is exposed. Therefore, the FRP can be easily repaired and recycled by a relatively compact and low-cost device using a laser light source.

Specifically, when the thermosetting resin is removed with the laser beam to a predetermined depth in the thickness direction of the FRP, or put differently, when removal of the thermosetting resin is done such that the thermosetting resin is left unremoved by a predetermined thickness without completely removed in the thickness direction of the FRP, repair of the FRP can be implemented by, for instance, applying the thermosetting resin anew to the region that the fiber material is exposed.

By contrast, when the thermosetting resin is completely removed by the laser beam in the thickness direction of the FRP, recycle of the FRP can be implemented by retrieving only the fiber material left unremoved.

### BRIEF DESCRIPTION OF THE DRAWINGS

Referring now to the attached drawings which form a part of this original disclosure:

FIG. 1 is a diagram showing a laser irradiation device 10 configured for implementing a method according to the present invention;

FIG. 2 is a cross-sectional view of an FRP blank S provided as an exemplary target for processing;

FIG. 3 is an exemplary cross-sectional view of the FRP blank S that has been processed with a laser beam L;

FIG. 4 is an exemplary cross-sectional view of a surface T of the FRP blank S that has been repaired;

FIG. 5 is a perspective view of the FRP blank S taking a three-dimensional (3D) shape as an exemplary target for processing;

FIG. 6 is a diagram showing FRP blanks S1 and S2 for forming the FRP blank S taking the three-dimensional (3D) shape as an exemplary target for processing;

FIG. 7 is a diagram showing the laser irradiation device 10 according to modification 1;

FIG. 8 is a diagram showing the laser irradiation device 10 according to modification 2; and

FIG. 9 is a diagram showing a surface B (target for processing) of the FRP blank S during processing with the laser irradiation device 10 according to modification 2.

### DETAILED DESCRIPTION OF EMBODIMENTS

(Configuration of Laser Irradiation Device 10)

A configuration of a laser irradiation device 10 will be hereinafter explained with reference to drawings. The laser irradiation device 10 is configured for implementing a method according to the present invention.

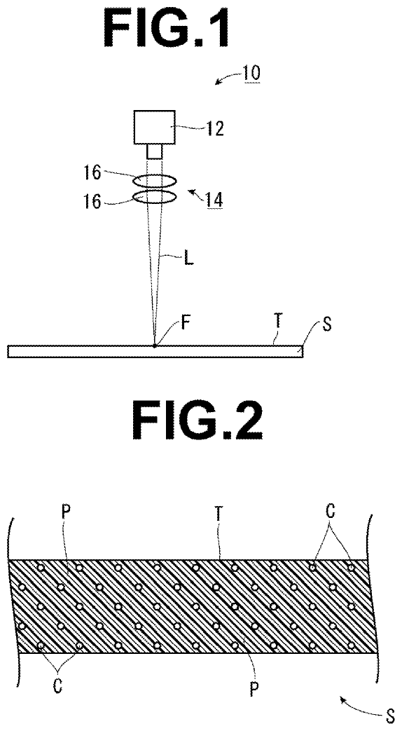

As shown in FIG. 1, the laser irradiation device 10 mainly includes a laser light source 12 and a light collector 14.

The laser light source 12 is a member for generating a laser beam L with a predetermined wavelength and a predetermined waveform. In the present exemplary embodiment, a laser diode (semiconductor laser) is used as the laser light source 12. Obviously, the laser light source 12 is not limited to this; for instance, a laser processing machine capable of generating the laser beam L with higher power may be used instead.

The light collector 14 is a member for concentrating the laser beam L irradiated from the laser light source 12 on a predetermined focal position F. In the present exemplary embodiment, double convex lenses 16 are used in combination with respect to the single laser light source 12 in order to configure the light collector 14. The focal position F is set on a surface T of FRP provided as a target for processing (FRP refers to CFRP in the present exemplary embodiment and will be hereinafter referred to as “FRP blank S”). It should be noted that the focal position F is not necessarily required to be set on the surface T of the FRP blank S as the target for processing if CFRP as the target for processing can be heated to a temperature at which the base material thereof can be removed. The configuration of the light collector 14 is not limited as well to that in the present exemplary embodiment. For example, a reflector may be used as the light collector 14, or alternatively, a lens and a reflector may be used in combination in order to form the light collector 14.

The laser beam L irradiated from the laser light source 12 is refracted at the light collector 14 and is then concentrated on the focal position F, i.e., the surface T of the FRP blank S.

(Removal of Thermosetting Resin from FRP Blank S)

The FRP blank S is normally formed by the following procedure: a plurality of prepreg sheets are laminated, and thereafter, the laminated prepreg sheets are pressure-bonded and hardened. As shown in FIG. 2, each prepreg sheet is herein made of a plurality of carbon fibers C extending approximately in parallel alignment with each other and has been impregnated with thermosetting resin Pin advance (e.g., epoxy resin). It should be noted that the method of forming the FRP blank S is not limited to this; for instance, INFUSION method or RTM (Resin Transfer Molding) may be employed instead.

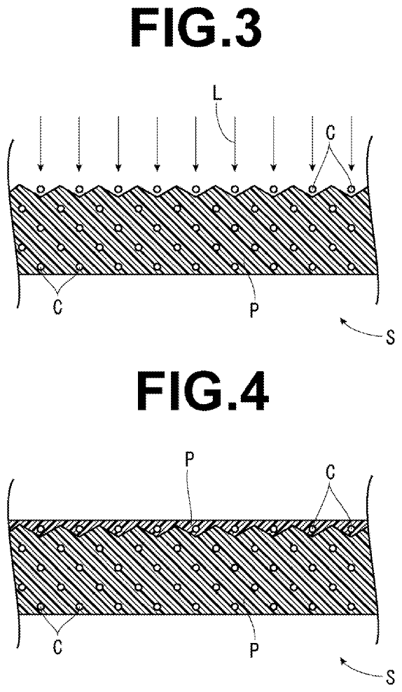

When the laser beam L, irradiated from the laser irradiation device 10 described above, is concentrated on the surface T of the FRP blank S, the temperature of the surface T is locally raised high in the irradiated position (focal position F) by the energy of the laser beam L. As shown in FIG. 3, the thermosetting resin P with a lower boiling point than the carbon fibers C evaporates first, while the carbon fibers C are left as unevaporated.

Irradiation of the laser beam L described above is sequentially executed in a predetermined direction, whereby the thermosetting resin P is removed in the surroundings of a group of carbon fibers C disposed in the closest position to the surface T; the group of carbon fibers C is exposed.

In exposing the carbon fibers C by removing the thermosetting resin P to a deeper position in the thickness (depth) direction of the FRP blank S, the carbon fibers C, already exposed, are removed firstly, and thereafter, the surface T is configured to be sequentially irradiated with the laser beam L again. It should be noted that, the larger the number of layers of removed carbon fibers C becomes, the deeper the position of the surface T irradiated with the laser beam L shifts in the thickness direction of the FRP blank S.

When it is intended to repair the FRP blank S, the thermosetting resin P is removed with the laser beam L as described above to a predetermined depth in the thickness direction of the FRP blank S; removal of the thermosetting resin P is done such that the thermosetting resin P is left unremoved by a predetermined thickness without completely removed in the thickness direction of the FRP blank S. Thereafter, as shown in FIG. 4, the thermosetting resin P is applied anew to and hardened on the region that the carbon fibers C are exposed. Thus, the repair of the FRP blank S can be implemented.

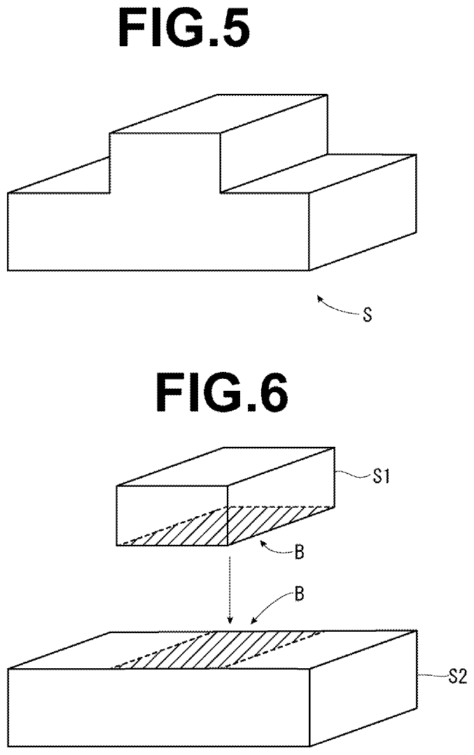

Furthermore, the method of processing FRP according to the present invention is applicable to forming the FRP blank S taking such a three-dimensional (3D) shape as shown in FIG. 5.

This will be specifically explained as follows. First, two FRP blanks S1 and S2 are prepared as shown in FIG. 6. Next, the method of processing FRP according to the present invention is applied to surfaces B (to be contacted to each other) of both FRP blanks S1 and S2; the carbon fibers C are exposed by removing the thermosetting resin P to a predetermined depth.

Thereafter, both blanks S1 and S2 are attached by the thermosetting resin P or adhesive applied to the surfaces B thereof. As a result, the FRP blank S taking such a three-dimensional (3D) shape as shown in FIG. 5 can be formed.

When it is intended to recycle the FRP blank S, the thermosetting resin P is completely removed by the laser beam L described above in the thickness direction of the FRP blank S. Thereafter, only the carbon fibers C left unremoved are retrieved. Thus, the recycle of the FRP blank S can be implemented.

As described above, by irradiating the laser beam L on the surface T of the FRP blank S, the thermosetting resin P is removed in the irradiated position (focal position F), whereby the carbon fibers C contained in the FRP blank S are exposed. Therefore, the FRP blank S can be easily repaired and recycled by a relatively compact and low-cost device using the laser light source 12.

### Modification 1

In the exemplary embodiment described above, the laser irradiation device 10 is composed of a single pair of the laser light source 12 and the light collector 14. Alternatively, the laser irradiation device 10 may be composed of a plurality of pairs of the laser light source 12 and the light collector 14 used in combination. At this time, the laser irradiation device 10 may be configured to irradiate a plurality of laser beams L from the respective laser light sources 12 onto a single irradiation position (focal position F) on the surface T of the FRP blank S in a superimposed manner.

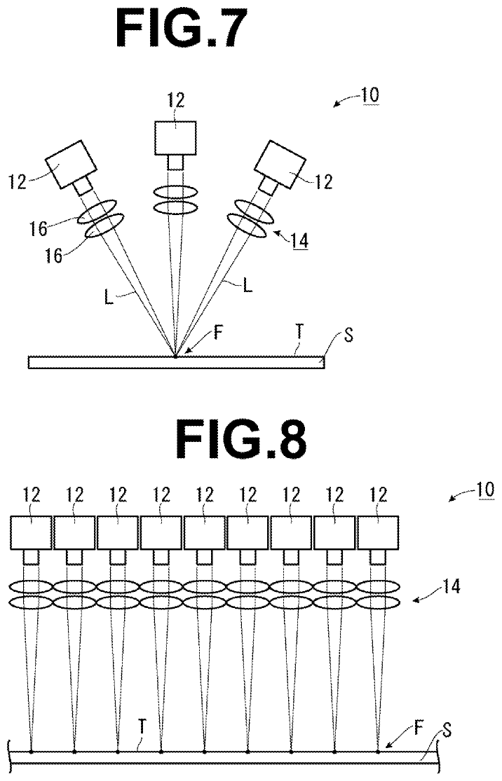

As shown in FIG. 7, the laser irradiation device 10 according to modification 1 is composed of, for instance, three pairs of the laser light source 12 and the light collector 14 used in combination.

### Modification 2

Alternatively, as shown in FIG. 8, the laser irradiation device 10 may be composed of a plurality of pairs of the laser light source 12 and the light collector 14 used in combination. At this time, the laser irradiation device 10 may be configured to irradiate a plurality of laser beams L from the respective laser light sources 12 onto a plurality of irradiated positions (focal positions F) set to be aligned in a row away from each other at a predetermined interval on the FRP blank S.

Obviously, the plural laser beams L may be configured to be irradiated onto a plurality of irradiated positions (focal positions F) on a one-to-one basis. Alternatively, the configuration explained in modification 1 may be combined with that herein explained; the plural laser beams L may be irradiated onto a single irradiated position (focal position F) in a superimposed manner. Furthermore, the plural laser beams L may be irradiated onto a plurality of irradiated positions (focal positions F) aligned in parallel to each other in two or more rows.

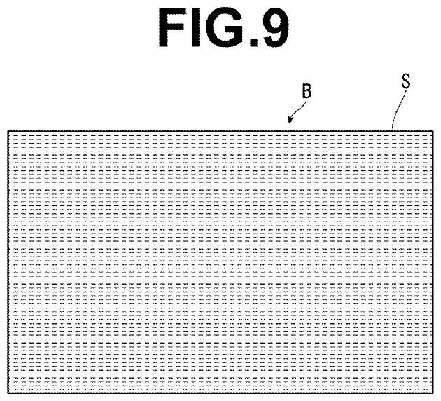

When the plural laser beams L are moved in a direction orthogonal to the row of the irradiated positions (focal positions F) thereof, the surface B (target for processing) of the FRP blank S can be processed at one time as shown in FIG. 9 by adjusting the intervals between the irradiated positions (focal positions F) and the intensity of the laser beams L. It should be noted that FIG. 9 depicts trajectories of the respective laser beams L with dotted lines.

### Modification 3

When the surface B of the FRP blank S to be processed is irradiated with the laser beam L, the opposite surface of the FRP blank S may be heated by a heating source (e.g., hot plate). Accordingly, the FRP blank S is heated by the heat from the heating source, whereby the FRP blank S can be processed with the laser beam L with lower power.

### Other Modifications

In addition, the FRP blank S containing unidirectionally aligned carbon fibers is herein used. However, the processing method according to the present invention is also applicable to process a type of FRP blank containing carbon fibers woven in plain or twill pattern in the vertical direction.

This is also true of various types of FRP blank using fiber material other than carbon, exemplified in the exemplary embodiment described above, such as glass fiber, ceramic fiber, aramid fiber, aluminum fiber, cellulose nanofiber, or so forth.

Although the invention has been described in its preferred form with a certain degree of particularity, it is understood that the present disclosure of the preferred form has been changed in the details of construction and the combination and arrangement of parts may be resorted to without departing from the spirit and scope of the invention as hereinafter claimed.

The disclosure of Japanese Patent Application No. 2019-194036 filed Oct. 25, 2019 including specification, drawings and claims is incorporated herein by reference in its entirety.

What is claimed is:

1. A method of processing FRP, comprising:
irradiating a laser beam onto a surface of the FRP to remove thermosetting resin from the FRP in an irradiated position of the laser beam such that fiber material contained in the FRP is exposed.

2. The method according to claim 1, wherein the fiber material is exposed by removing the thermosetting resin to a predetermined depth in a thickness direction of the FRP.

3. The method according to claim 1, further comprising:
irradiating a plurality of laser beams including the laser beam in irradiated positions at least aligned in a row away from each other at a predetermined interval; and
moving the plurality of laser beams in a direction orthogonal to the row of the irradiated positions of the plurality of laser beams.

4. The method according to any one of claim 1, wherein a plurality of laser beams including the laser beam are irradiated onto the surface of the FRP in the irradiated position of the laser beam as a single irradiation position in a superimposed manner.
